(19) United States
(12) Patent Application Publication
(10) Pub. No.: US 2017/0247636 A1
(43) Pub. Date: Aug. 31, 2017

(54) LIQUID WHITENING COMPOSITION

(71) Applicant: Conopco, Inc., d/b/a UNILEVER, Englewood Cliffs, NJ (US)

(72) Inventor: Stephen Norman BATCHELOR, Chester, Cheshire (GB)

(73) Assignee: Conopco, Inc., d/b/a UNILEVER, Englewood Cliffs, NJ (US)

(21) Appl. No.: 15/509,036

(22) PCT Filed: Jun. 22, 2015
(86) PCT No.: PCT/EP2015/063927

§ 371 Date: Mar. 6, 2017

(30) Foreign Application Priority Data
Sep. 18, 2014 (EP) 14185263.2

(51) Int. Cl. C11D 1/83; C11D 1/22; C11D 1/29; C11D 1/37; C11D 17/06; C11D 3/00; C11D 3/37; C11D 3/50; C11D 11/00; C11D 1/14; C11D 1/72

(52) U.S. Cl. CPC C11D 1/83; C11D 1/146; C11D 1/22; C11D 1/29; C11D 1/37; C11D 1/72; C11D 3/0036; C11D 3/3707; C11D 3/50; C11D 11/0017; C11D 17/06

(57) ABSTRACT

The present invention provides an aqueous liquid non-phosphate built domestic laundry whitening and brightening composition comprising charged surfactant, uncharged alkoxylated polyarylphenol and perfume.

### FIELD OF INVENTION

The present invention concerns the use of whitening and brightening laundry compositions.

### BACKGROUND OF THE INVENTION

Maintaining and improving the whiteness and brightness of textiles during domestic laundry are desirable. A problem is the redeposition of soil removed from one garment onto another. The problem is exacerbated by the presence of human oils (sebum) on garments and in the wash which serves to enhance the deposition of soil in the wash. This process leads to an overall loss of whiteness and cleaning across the washing load. To ameliorate this problem, dispersing polymer such as an alkoxylated polyethylene imines have been widely added to washing detergents. Ethoxylated PEI (PEI=polyethylene imine) is known as an anti redeposition polymer from CA 121 0009. Certain Cellulase enzymes have also been used to prevent redeposition by altering the surface properties of cotton fabrics. Novozymes describes in WO02/099091 and WO04/053039 cellulases for use in domestic laundry.

EP1321510 (Shipley) describes an industrial cleaning composition that contain an alkoxylated polyarylphenol for stripping organic chemical residues from photoresists that are used in the manufacture of semi-conductors and other electronic devices and circuits. The organic chemical residues are materials left over from the production process and include photoinitiators, thermoinitiators, acrylic and methacrylic monomers.

### SUMMARY OF THE INVENTION

There is a need for further technologies to reduce redeposition and enhance cleaning in domestic laundry products.

We have found that uncharged alkoxylated polyarylphenols enhance whiteness and brightness of garments during domestic laundry.

In one aspect the present invention provides a non-phosphate built laundry detergent comprising:
(i) charged surfactant, preferably the level of charged surfactant is from 4 to 50 wt %, more preferably 6 to 30 wt %, most preferably 8 to 20 wt %;
(ii) uncharged alkoxylated polyarylphenol, preferably at a level of from 0.1 to 20 wt %, more preferably 0.5 to 10 wt %, most preferably 2 to 9 wt %; and.
(iii) perfume, preferably 0.05 to 0.5 wt % perfume, wherein the laundry detergent is an aqueous liquid laundry detergent.

In another aspect the present invention provides a non-phosphate built laundry detergent comprising:
(i) from 4 to 50 wt %, preferably 6 to 30 wt %, most preferably 8 to 20 wt %, of anionic surfactant selected from: linear alkyl benzene sulphonates; alkyl sulphates; alkyl ether sulphates; and mixtures thereof;
(ii) from 0.5 to 10 wt %, preferably 2 to 9 wt %, of uncharged alkoxylated polyarylphenol of the following structure:

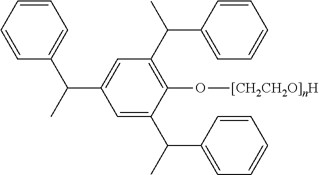

wherein n is selected from: 10; 11; 12; 13; 14; 15; 16; 17; 18; 19; 20; 21; 22; 23; 24; 25; 26; 27; 28; 29; 30; 31; 32; 33; 34; 35; 36; 37; 38; 39; 40; 41; 42; 43; 44; 45; 46; 47; 48; 49; 50; 51; 52; 53; and, 54; and
(iii) perfume, preferably from 0.05 to 0.5 wt % perfume, wherein the laundry detergent is an aqueous liquid laundry detergent.

In a further aspect the present invention provides a domestic method of treating a textile, the method comprising the steps of:
(i) treating a textile with an aqueous solution of the uncharged alkoxylated polyarylphenol as, the aqueous solution comprising from 10 ppm to 5000 ppm of the uncharged alkoxylated polyarylphenol; and, up to 6 g/L, preferably 0.2 to 4 g/L, of one or more surfactants; and,
(ii) optionally rinsing and drying the textile.

In the method the level of the perfume in the aqueous solution is preferably from 0.1 to 100 ppm, more preferably 1 to 10 ppm.

In the method aspects of the present invention the surfactant used is preferably as preferred for the composition aspects of the present invention.

The textile is preferably an item of clothing, bedding or table cloth. Preferred items of clothing are cotton containing shirts, trousers, underwear and jumpers.

### DETAILED DESCRIPTION OF THE INVENTION

Alkoxvlated Polvarvlphenol

Preferably the uncharged (neutral) alkoxylated polyarylphenol is an alkoxylated tristyrylphenol.

Preferably the alkoxylated tristyrylphenol is a polyethylene glycol mono(2,4,6-tris(1-phenylethyl)phenyl) ether. Preferably the alkoxylated polyarylphenol contains an average of 2 to 70 alkoxy groups, most preferably 10 to 54 alkoxy groups.

Preferably the alkoxylation is ethoxylation.

Preferably the alkoxylated polyarylphenol has 2 or 3 aryl groups attached to the phenol. Preferably they are in the 2,4 or 2,4,6 position on the phenol. The alkoxylate is attached to the 1 position. Preferably the alkoxylate is capped by a hydrogen atom.

The aryl group in the alkoxylated polyarylphenol is preferably selected from, phenyl, tolyl, naphthyl, tetrahydronaphthyl, indanyl, indenyl, styryl, pyridyl, quinolinyl, and mixtures thereof.

Most preferably, the alkoxylated polyarylphenol is polyethylene glycol mono(2,4,6-tris(1-phenylethyl)phenyl) ether (CAS-No: 70559-25-0) with the following structure:

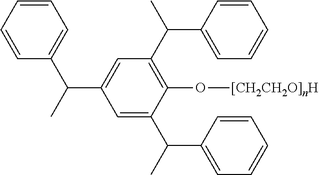

Preferably n=2 to 70, more preferably n=10 to 54, most preferably n=16 and n=20.

The designation n is the average numbers of moles of alkoxy units in the polyalkoxy chain.

Compounds are available from industrial suppliers, for example Rhodia under the Soprophor trade name; from Clariant under the Emulsogen trade name; Aoki Oil Industrial Co under the Blaunon trade name; from Stepan under the Makon trade name; from TOHO Chemical Industry Co under the Sorpol trade name.

In the context of the current invention the alkoxylated polyarylphenol is not considered a surfactant and does not contribute numerically to the surfactant as defined herein.

Surfactant

The laundry composition comprises charged surfactant and it is most preferred that the charged surfactant is anionic surfactant (which includes a mixture of the same).

Suitable anionic detergent compounds which may be used are usually water-soluble alkali metal salts of organic sulphates and sulphonates having alkyl radicals containing from about 8 to about 22 carbon atoms, the term alkyl being used to include the alkyl portion of higher alkyl radicals.

Examples of suitable synthetic anionic detergent compounds are sodium and potassium alkyl sulphates, especially those obtained by sulphating higher C₈ to C₁₈ alcohols, produced for example from tallow or coconut oil, sodium and potassium alkyl C₉ to C₂₀ benzene sulphonates, particularly sodium linear secondary alkyl C₁₀ to C₁₅ benzene sulphonates; and sodium alkyl glyceryl ether sulphates, especially those ethers of the higher alcohols derived from tallow or coconut oil and synthetic alcohols derived from petroleum.

The anionic surfactant is preferably selected from: linear alkyl benzene sulphonate; alkyl sulphates; alkyl ether sulphates; soaps; alkyl (preferably methyl) ester sulphonates, and mixtures thereof.

The most preferred anionic surfactants are selected from: linear alkyl benzene sulphonate; alkyl sulphates; alkyl ether sulphates and mixtures thereof. Preferably the alkyl ether sulphate is a C₁₂-C₁₄ n-alkyl ether sulphate with an average of 1 to 3EO (ethoxylate) units. Sodium lauryl ether sulphate is particularly preferred (SLES). Preferably the linear alkyl benzene sulphonate is a sodium C₁₁ to C₁₅ alkyl benzene sulphonates. Preferably the alkyl sulphates is a linear or branched sodium C₁₂ to C₁₈ alkyl sulphates. Sodium dodecyl sulphate is particularly preferred, (SDS, also known as primary alkyl sulphate).

The level of anionic surfactant in the laundry composition is preferably from 4 to 50 wt %, more preferably 6 to 30 wt %, and most preferably 8 to 20 wt %.

Preferably two or more anionic surfactant are present, for example linear alkyl benzene sulphonate together with an alkyl ether sulphate.

Preferably the laundry composition in addition to the anionic surfactant comprises alkyl exthoylated non-ionic surfactant, preferably from 2 to 8 wt % of alkyl alkoxylated, preferably ethoxylated, non-ionic surfactant.

Suitable nonionic detergent compounds which may be used include, in particular, the reaction products of compounds having an aliphatic hydrophobic group and a reactive hydrogen atom, for example, aliphatic alcohols, acids or amides, especially ethylene oxide either alone or with propylene oxide. Specific nonionic detergent compounds are the condensation products of aliphatic C₈ to C₁₈ primary or secondary linear or branched alcohols with ethylene oxide.

Preferably the alkyl ethoxylated non-ionic surfactant is a C₈ to C₁₈ primary alcohol with an average ethoxylation of 7EO to 9EO units.

The nonionic and anionic surfactants of the surfactant system may be chosen from the surfactants described “Surface Active Agents” Vol. 1, by Schwartz & Perry, Interscience 1949, Vol. 2 by Schwartz, Perry & Berch, Interscience 1958, in the current edition of “McCutcheon's Emulsifiers and Detergents” published by Manufacturing Confectioners Company or in “Tenside-Taschenbuch”, H. Stache, 2nd Edn., Carl Hauser Verlag, 1981.

Preferably the surfactants used are saturated.

Also applicable are surfactants such as those described in EP-A-328 177 (Unilever), which show resistance to salting-out, the alkyl polyglycoside surfactants described in EP-A-070 074, and alkyl monoglycosides.

In another aspect the charged surfactant may be a cationic such that the formulation is a fabric conditioner. The detergent compositions based on anionic or anionic/non-ionic surfactants is however the more preferred embodiment.

Cationic Compound

When the present invention is used as a fabric conditioner it needs to contain a cationic compound.

Most preferred are quaternary ammonium compounds.

It is advantageous if the quaternary ammonium compound is a quaternary ammonium compound having at least one C₁₂ to C₂₂ alkyl chain.

It is preferred if the quaternary ammonium compound has the following formula:

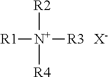

in which R¹ is a C₁₂ to C₂₂ alkyl or alkenyl chain; R², R³ and R⁴ are independently selected from C₁ to C₄ alkyl chains and X⁻is a compatible anion. A preferred compound of this type is the quaternary ammonium compound cetyl trimethyl quaternary ammonium bromide.

A second class of materials for use with the present invention are the quaternary ammonium of the above structure in which R¹ and R² are independently selected from C₁₂ to C₂₂ alkyl or alkenyl chain; R³ and R⁴ are independently selected from C₁ to C₄ alkyl chains and X⁻is a compatible anion.

The composition optionally comprises a silicone.

Builders or Complexing Agents

Builder materials may be selected from 1) calcium sequestrant materials, 2) precipitating materials, 3) calcium ion-exchange materials and 4) mixtures thereof.

Examples of calcium sequestrant builder materials include alkali metal polyphosphates, such as sodium tripolyphosphate and organic sequestrants, such as ethylene diamine tetra-acetic acid.

Examples of precipitating builder materials include sodium orthophosphate and sodium carbonate.

The composition may also contain 0-65% of a builder or complexing agent such as ethylenediaminetetraacetic acid, diethylenetriamine-pentaacetic acid, alkyl- or alkenylsuccinic acid, nitrilotriacetic acid or the other builders mentioned below. Many builders are also bleach-stabilising agents by virtue of their ability to complex metal ions.

Preferably the laundry detergent formulation is a non-phosphate built laundry detergent formulation, i.e., contains less than 1 wt % of phosphate.

The laundry detergent is an aqueous liquid laundry detergent, preferably with a pH of from 7 to 9.

In the aqueous liquid laundry detergent it is preferred that mono propylene glycol is present at a level from 1 to 30 wt %, most preferably 2 to 18 wt %, to provide the formulation with appropriate pourable viscosity.

Fluorescent Agent

The composition preferably comprises a fluorescent agent (optical brightener). Fluorescent agents are well known and many such fluorescent agents are available commercially. Usually, these fluorescent agents are supplied and used in the form of their alkali metal salts, for example, the sodium salts. Preferred classes of fluorescer are: Di-styryl biphenyl compounds, e.g. Tinopal (Trade Mark) CBS-X, Di-amine stilbene di-sulphonic acid compounds, e.g. Tinopal DMS pure Xtra and Blankophor (Trade Mark) HRH, and Pyrazoline compounds, e.g. Blankophor SN. Preferred fluorescers are: sodium 2 (4-styryl-3-sulphophenyl)-2H-napthol[1,2-d]triazole, disodium 4,4′-bis{[(4-anilino-6-(N methyl-N-2 hydroxyethyl) amino 1,3,5-triazin-2-yl)]amino{stilbene-2-2′ disulphonate, disodium 4,4′-bis{[(4-anilino-6-morpholino-1,3,5-triazin-2-yl)]amino{stilbene-2-2′ disulphonate, and disodium 4,4′-bis(2-sulphostyryl)biphenyl.

Perfume

The composition comprises a perfume. The perfume is preferably in the range from 0.001 to 3 wt %, more preferably 0.05 to 0.5 wt %, most preferably 0.1 to 1 wt %. Many suitable examples of perfumes are provided in the CTFA (Cosmetic, Toiletry and Fragrance Association) 1992 International Buyers Guide, published by CFTA Publications and OPD 1993 Chemicals Buyers Directory 80th Annual Edition, published by Schnell Publishing Co.

Preferably the perfume comprises at least one note (compound) from: alpha-isomethyl ionone, benzyl salicylate; citronellol; coumarin; hexyl cinnamal; linalool; pentanoic acid, 2-methyl-, ethyl ester; octanal; benzyl acetate; 1,6-octadien-3-ol, 3,7-dimethyl-, 3-acetate; cyclohexanol, 2-(1,1-dimethylethyl)-, 1-acetate; delta-damascone; beta-ionone; verdyl acetate; dodecanal; hexyl cinnamic aldehyde; cyclopentadecanolide; benzeneacetic acid, 2-phenylethyl ester;amyl salicylate; beta-caryophyllene; ethyl undecylenate; geranyl anthranilate; alpha-irone; beta-phenyl ethyl benzoate; alpa-santalol; cedrol; cedryl acetate; cedry formate; cyclohexyl salicyate; gamma-dodecalactone; and, beta phenylethyl phenyl acetate.

Useful components of the perfume include materials of both natural and synthetic origin. They include single compounds and mixtures. Specific examples of such components may be found in the current literature, e.g., in Fenaroli's Handbook of Flavor Ingredients, 1975, CRC Press; Synthetic Food Adjuncts, 1947 by M. B. Jacobs, edited by Van Nostrand; or Perfume and Flavor Chemicals by S. Arctander 1969, Montclair, N.J. (USA).

It is commonplace for a plurality of perfume components to be present in a formulation. In the compositions of the present invention it is envisaged that there will be four or more, preferably five or more, more preferably six or more or even seven or more different perfume components.

In perfume mixtures preferably 15 to 25 wt % are top notes. Top notes are defined by Poucher (Journal of the Society of Cosmetic Chemists 6(2):80 [1955]). Preferred top-notes are selected from citrus oils, linalool, linalyl acetate, lavender, dihydromyrcenol, rose oxide and cis-3-hexanol.

The International Fragrance Association has published a list of fragrance ingredients (perfums) in 2011. (http://www.ifraorg.org/en-us/ingredients#.U7Z4hPldWzk)

The Research Institute for Fragrance Materials provides a database of perfumes (fragrances) with safety information.

Perfume top note may be used to cue the whiteness and brightness benefit of the invention.

Some or all of the perfume may be encapsulated, typical perfume components which it is advantageous to encapsulate, include those with a relatively low boiling point, preferably those with a boiling point of less than 300, preferably 100-250 Celsius. It is also advantageous to encapsulate perfume components which have a low CLog P (ie. those which will have a greater tendency to be partitioned into water), preferably with a CLog P of less than 3.0. These materials, of relatively low boiling point and relatively low CLog P have been called the “delayed blooming” perfume ingredients and include one or more of the following materials: allyl caproate, amyl acetate, amyl propionate, anisic aldehyde, anisole, benzaldehyde, benzyl acetate, benzyl acetone, benzyl alcohol, benzyl formate, benzyl iso valerate, benzyl propionate, beta gamma hexenol, camphor gum, laevo-carvone, d-carvone, cinnamic alcohol, cinamyl formate, cis-jasmone, cis-3-hexenyl acetate, cuminic alcohol, cyclal c, dimethyl benzyl carbinol, dimethyl benzyl carbinol acetate, ethyl acetate, ethyl aceto acetate, ethyl amyl ketone, ethyl benzoate, ethyl butyrate, ethyl hexyl ketone, ethyl phenyl acetate, eucalyptol, eugenol, fenchyl acetate, flor acetate (tricyclo decenyl acetate), frutene (tricycico decenyl propionate), geraniol, hexenol, hexenyl acetate, hexyl acetate, hexyl formate, hydratropic alcohol, hydroxycitronellal, indone, isoamyl alcohol, iso menthone, isopulegyl acetate, isoquinolone, ligustral, linalool, linalool oxide, linalyl formate, menthone, menthyl acetphenone, methyl amyl ketone, methyl anthranilate, methyl benzoate, methyl benyl acetate, methyl eugenol, methyl heptenone, methyl heptine carbonate, methyl heptyl ketone, methyl hexyl ketone, methyl phenyl carbinyl acetate, methyl salicylate, methyl-n-methyl anthranilate, nerol, octalactone, octyl alcohol, p-cresol, p-cresol methyl ether, p-methoxy acetophenone, p-methyl acetophenone, phenoxy ethanol, phenyl acetaldehyde, phenyl ethyl acetate, phenyl ethyl alcohol, phenyl ethyl dimethyl carbinol, prenyl acetate, propyl bornate, pulegone, rose oxide, safrole, 4-terpinenol, alpha-terpinenol, and/or viridine. It is commonplace for a plurality of perfume components to be present in a formulation. In the compositions of the present invention it is envisaged that there will be four or more, preferably five or more, more preferably six or more or even seven or more different perfume components from the list given of delayed blooming perfumes given above present in the perfume.

Another group of perfumes with which the present invention can be applied are the so-called ‘aromatherapy’ materials. These include many components also used in perfumery, including components of essential oils such as clary sage, eucalyptus, geranium, lavender, mace extract, neroli, nutmeg, spearmint, sweet violet leaf and valerian.

It is preferred that the laundry treatment composition does not contain a peroxygen bleach, e.g., sodium percarbonate, sodium perborate, and peracid.

Polymers

The composition may comprise one or more further polymers. Examples are carboxymethylcellulose, poly (ethylene glycol), poly(vinyl alcohol), polycarboxylates such as polyacrylates, maleic/acrylic acid copolymers and lauryl methacrylate/acrylic acid copolymers.

Polymers present to prevent dye deposition may be present, for example poly(vinylpyrrolidone), poly(vinylpyridine-N-oxide), and poly(vinylimidazole).

Enzymes

One or more enzymes are preferred present in a laundry composition of the invention and when practicing a method of the invention.

Preferably the level of each enzyme in the laundry composition of the invention is from 0.0001 wt % to 0.1 wt % protein.

Preferably the enzyme is selected from: proteases; lipases; and, cellulases, preferably a protease.

Especially contemplated enzymes include proteases, alpha-amylases, cellulases, lipases, peroxidases/oxidases, pectate lyases, and mannanases, or mixtures thereof.

Suitable lipases include those of bacterial or fungal origin. Chemically modified or protein engineered mutants are included. Examples of useful lipases include lipases from Humicola (synonym Thermomyces), e.g. from H. lanuginosa (T. lanuginosus) as described in EP 258 068 and EP 305 216 or from H. insolens as described in WO 96/13580, a Pseudomonas lipase, e.g. from P. alcaligenes or P. pseudoalcaligenes (EP 218 272), P. cepacia (EP 331 376), P. stutzeri (GB 1,372,034), P. fluorescens, Pseudomonas sp. strain SD 705 (WO 95/06720 and

WO 96/27002), P. wisconsinensis (WO 96/12012), a Bacillus lipase, e.g. from B. subtilis (Dartois et al. (1993), Biochemica et Biophysica Acta, 1131, 253-360), B. stearothermophilus (JP 64/744992) or B. pumilus (WO 91/16422).

Other examples are lipase variants such as those described in WO 92/05249, WO 94/01541, EP 407 225, EP 260 105, WO 95/35381, WO 96/00292, WO 95/30744, WO 94/25578, WO 95/14783, WO 95/22615, WO 97/04079 and WO 97/07202, WO 00/60063.

Preferred commercially available lipase enzymes include Lipolase™ and Lipolase Ultra™, Lipex™ and Lipoclean™ (Novozymes NS).

The method of the invention may be carried out in the presence of phospholipase classified as EC 3.1.1.4 and/or EC 3.1.1.32. As used herein, the term phospholipase is an enzyme which has activity towards phospholipids.

Phospholipids, such as lecithin or phosphatidylcholine, consist of glycerol esterified with two fatty acids in an outer (sn-1) and the middle (sn-2) positions and esterified with phosphoric acid in the third position; the phosphoric acid, in turn, may be esterified to an amino-alcohol. Phospholipases are enzymes which participate in the hydrolysis of phospholipids. Several types of phospholipase activity can be distinguished, including phospholipases A₁ and A2 which hydrolyze one fatty acyl group (in the sn-1 and sn-2 position, respectively) to form lysophospholipid; and lysophospholipase (or phospholipase B) which can hydrolyze the remaining fatty acyl group in lysophospholipid. Phospholipase C and phospholipase D (phosphodiesterases) release diacyl glycerol or phosphatidic acid respectively.

Suitable proteases include those of animal, vegetable or microbial origin. Microbial origin is preferred. Chemically modified or protein engineered mutants are included. The protease may be a serine protease or a metallo protease, preferably an alkaline microbial protease or a trypsin-like protease. Preferred commercially available protease enzymes include Alcalase™, Savinase™, Primase™, Duralase™, Dyrazym™, Esperase™, Everlase™, Polarzyme™, and Kannase™, (Novozymes NS), Maxatase™, Maxacal™, Maxapem™, Properase™, Purafect™, Purafect OxP™, FN2™, and FN3™ (Genencor International Inc.).

The method of the invention may be carried out in the presence of cutinase, classified in EC 3.1.1.74. The cutinase used according to the invention may be of any origin. Preferably cutinases are of microbial origin, in particular of bacterial, of fungal or of yeast origin.

Suitable amylases (alpha and/or beta) include those of bacterial or fungal origin. Chemically modified or protein engineered mutants are included. Amylases include, for example, alpha-amylases obtained from Bacillus, e.g. a special strain of B. licheniformis, described in more detail in GB 1,296,839, or the Bacillus sp. strains disclosed in WO 95/026397 or WO 00/060060. Commercially available amylases are Duramyl™, Termamyl™, Termamyl Ultra™, Natalase™, Stainzyme™, Fungamyl™ and BAN™ (Novozymes A/S), Rapidase™ and Purastar™ (from Genencor International Inc.).

Suitable cellulases include those of bacterial or fungal origin. Chemically modified or protein engineered mutants are included. Suitable cellulases include cellulases from the genera Bacillus, Pseudomonas, Humicola, Fusarium, Thielavia, Acremonium, e.g. the fungal cellulases produced from Humicola insolens, Thielavia terrestris, Myceliophthora thermophila, and Fusarium oxysporum disclosed in U.S. Pat. No. 4,435,307, U.S. Pat. No. 5,648,263, U.S. Pat. No. 5,691,178, U.S. Pat. No. 5,776,757, WO 89/09259, WO 96/029397, and WO 98/012307. Commercially available cellulases include Celluzyme™, Carezyme™, Celluclean ™, Endolase™, Renozyme™ (Novozymes A/S), Clazinase™ and Puradax HA™ (Genencor International Inc.), and KAC-500(B)™ (Kao Corporation). Celluclean™ is preferred.

Suitable peroxidases/oxidases include those of plant, bacterial or fungal origin. Chemically modified or protein engineered mutants are included. Examples of useful peroxidases include peroxidases from Coprinus, e.g. from C. cinereus, and variants thereof as those described in WO 93/24618, WO 95/10602, and WO 98/15257. Commercially available peroxidases include Guardzyme™ and Novozym™ 51004 (Novozymes A/S).

Further enzymes suitable for use are discussed in WO2009/087524, WO2009/090576, WO2009/107091, WO2009/111258 and WO2009/148983.

Enzyme Stabilizers

Any enzyme present in the composition may be stabilized using conventional stabilizing agents, e.g., a polyol such as propylene glycol or glycerol, a sugar or sugar alcohol, lactic acid, boric acid, or a boric acid derivative, e.g., an aromatic borate ester, or a phenyl boronic acid derivative such as 4-formylphenyl boronic acid, and the composition may be formulated as described in e.g. WO 92/19709 and WO 92/19708.

Where alkyl groups are sufficiently long to form branched or cyclic chains, the alkyl groups encompass branched, cyclic and linear alkyl chains. The alkyl groups are preferably linear or branched, most preferably linear.

The indefinite article “a” or “an” and its corresponding definite article “the” as used herein means at least one, or one or more, unless specified otherwise.

Experimental

### EXAMPLE 1

An aqueous liquid laundry detergent was prepared of the following formulation:

| Ingredient | Weight % |
|---|---|
| Mono propylene glycol | 2 |
| Trimethylamine | 1.5 |
| C12-C15 alcohol ethoxylate with 7 moles of ethylene oxide | 2.1 |
| Linear alkyl benzene sulfonate | 8.4 |
| Sodium laureth ether sulphate with 3 moles of ethylene oxide | 10.5 |
| Citric acid | 0.5 |
| Perfume | 0.3 |
| Anti-redeposition technology | See text |
| Sodium Hydroxide | To |
| | pH = 8.4 |
| Water | balance |

The formulation was used to wash eight 5×5cm knitted cotton cloth pieces in a tergotometer set at 200 rpm. A one hour wash was conducted in 800 ml of 6° French Hard water at 20° C., with 2.3 g/L of the formulation. To simulate particulate soil 0.04 g/L of 100% compressed carbon black (ex Sigma-Aldrich) was added to the wash liquor. To simulate oily soil (12.5 g) of an SBL2004 soil strip (ex Warwick Equest) was added to the wash liquor.

Once the wash had been completed the cotton monitors were rinsed twice in 500m1 clean water, removed dried and the colour measured on a reflectometer and expressed as the CIE L*a*b* values.

Formulations were tested containing varying levels of Sokalan HP20 (BASF), an ethoxylated polyethylene imine polymer PEI(600) 20EO, as a comparison polymer for anti-redeposition benefits.

Formulation were tested containing varying levels of the Alkoxylated polyarylphenol : polyethylene glycol mono(2,4,6-tris(1-phenylethyl)phenyl) ether with an average of 16 ethoxylate groups. (Emulsogen TS160 ex Clariant).

The results are summarised in the table below. The 95% confidence limits are also given calculated from the standard deviation on the measurements from the 8 monitors. The L* value is the mean of the measurements from the 8 monitors.

| | PEI(600) 20EO | | Alkoxylated polyarylphenol | |
|---|---|---|---|---|
| | (comparative) | | (invention) | |
| wt % polymer | L* | 95% | L* | 95% |
| 0 | 75.51 | 0.35 | 75.40 | 0.23 |
| 2.2 | 75.40 | 0.29 | 76.78 | 0.23 |
| 4.3 | 76.45 | 0.34 | 78.61 | 0.32 |
| 8.7 | 75.86 | 0.32 | 79.83 | 0.22 |

The alkoxylated polyarylphenol increased the L* of the monitors in a dose dependent manner. High L* values equate to a cleaner, whiter fabrics. The alkoxylated polyarylphenol provides significantly better benefits than the ethoxylated polyethyleneimine.

1. A non-phosphate built laundry detergent comprising:
(i) from 4 to 50 wt % of a charged surfactant;
(ii) from 0.1 to 20 wt % uncharged alkoxylated polyarylphenol, wherein the alkoxylate is capped by a hydrogen atom; and,
(iii) from 0.001 to 3 wt % of a perfume, wherein the laundry detergent is an aqueous liquid laundry detergent

2. A laundry detergent composition according to claim 1, wherein the uncharged alkoxylated polyarylphenol is uncharged alkoxylated tristyrylphenol and the pH of the aqueous liquid laundry detergent is from 7 to 9.

3. A laundry detergent composition according to claim 1, wherein the uncharged alkoxylated polyarylphenol is uncharged ethoxylated polyarylphenol and the pH of the aqueous liquid laundry detergent is from 7 to 9.

4. A laundry detergent composition according to claim 2, wherein the uncharged alkoxylated tristyrylphenol is uncharged polyethylene glycol mono(2,4,6-tris(1-phenylethyl) phenyl) ether.

5. A laundry detergent composition according to claim 1, wherein the uncharged alkoxylated polyarylphenol contains an average of 2 to 70 alkoxy groups.

6. A laundry detergent composition according to claim 5, wherein the uncharged alkoxylated polyarylphenol contains an average of 10 to 54 alkoxy groups.

7. A laundry detergent composition according to claim 1, wherein the uncharged alkoxylated polyarylphenol is present at a level of from 0.5 to 10 wt %, most preferably 2 to 9 wt %.

8. A laundry detergent composition according to claim 1 wherein the charged surfactant is anionic surfactant.

9. A laundry detergent composition according to claim 8, wherein the anionic surfactant is selected from: linear alkyl benzene sulphonate; alkyl sulphates; alkyl ether sulphates; soaps, alkyl (preferably methyl) ester sulphonates and mixtures thereof.

10. A laundry detergent composition according to claim 9, wherein the anionic surfactant is selected from: linear alkyl benzene sulphonate; alkyl sulphates; alkyl ether sulphates and mixtures thereof.

11. A laundry detergent composition according to any one of the preceding claims, wherein the level of anionic surfactant is from 4 to 50 wt %.

12. A laundry detergent composition according to claim 1 wherein the composition comprises from 2 to 8 wt % of alkyl ethoxylated non-ionic surfactant.

13. A laundry detergent composition according to claim 1 wherein perfume is present from 0.001 to 3 wt % and comprises one or more note compound from: alpha-isomethyl ionone, benzyl salicylate; citronellol; coumarin; hexyl cinnamal; linalool; pentanoic acid, 2-methyl-, ethyl ester; octanal; benzyl acetate; 1,6-octadien-3-ol, 3,7-dimethyl-, 3-acetate; cyclohexanol, 2-(1,1-dimethylethyl)-, 1-acetate; delta-damascone; beta-ionone; verdyl acetate; dodecanal; hexyl cinnamic aldehyde; cyclopentadecanolide; benzeneacetic acid, 2-phenylethyl ester;amyl salicylate; beta-caryophyllene; ethyl undecylenate; geranyl anthranilate; alpha-irone; beta-phenyl ethyl benzoate; alpa-santalol; cedrol; cedryl acetate; cedry formate; cyclohexyl salicyate; gamma-dodecalactone; and, beta phenylethyl phenyl acetate.

14. A non-phosphate built laundry detergent according to claim 1 comprising:
(i) from 4 to 50 wt % of anionic surfactant selected from: linear alkyl benzene sulphonate; alkyl sulphate; alkyl ether sulphate; and mixtures thereof.
(ii) from 0.5 to 10 wt % of uncharged alkoxylated polyarylphenol of the following structure: 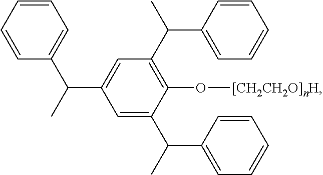
wherein n is selected from: 10; 11; 12; 13; 14; 15; 16; 17; 18; 19; 20; 21; 22; 23; 24; 25; 26; 27; 28; 29; 30; 31; 32; 33; 34; 35; 36; 37; 38; 39; 40; 41; 42; 43; 44; 45; 46; 47; 48; 49; 50; 51; 52; 53; and, 54; and,
(iii) perfume, wherein the laundry detergent is an aqueous liquid laundry detergent.

15. A laundry detergent composition according to claim 1 wherein the composition comprises from 0.0001 wt % to 0.1 wt % protein of an enzyme selected from: proteases; lipases; cellulases; and mixtures thereof preferably comprising a protease.

16. A laundry detergent composition according to claim 1 wherein the laundry detergent composition is a laundry aqueous liquid detergent composition.

17. A domestic method of treating a textile, the method comprising the steps of:
(i) treating said textile with an aqueous solution of a laundry detergent composition as defined in claim 1 the aqueous solution comprising from 10 ppm to 5000 ppm of uncharged alkoxylated polyarylphenol; and, up to 6 g/L of surfactant; and,
(ii) optionally rinsing and drying said textile.

18. A domestic method of treating a textile according to claim 17, wherein the aqueous solution comprises from 0.2 to 4 g/L of surfactant.
